(19) United States
(12) Patent Application Publication
(10) Pub. No.: US 2026/0219400 A1
(43) Pub. Date: Jul. 30, 2026

(54) NAVIGATION DEVICE, AND METHOD FOR DETERMINING A NAVIGATION SOLUTION

(71) Applicant: Northrop Grumman Litef GmbH, Freiburg (DE)

(72) Inventors: Pia HERTENSTEIN, Freiburg (DE); Tim MARTIN, Freiburg (DE)

(21) Appl. No.: 19/149,647

(22) PCT Filed: Dec. 14, 2023
(86) PCT No.: PCT/EP2023/085826

§ 371 Date: Jul. 21, 2025

(30) Foreign Application Priority Data
Jan. 25, 2023 (DE) 10 2023 101 785.3

(51) Int. Cl. G01S 19/47; G01C 21/16

(52) U.S. Cl. CPC G01S 19/47; G01C 21/1652

(57) ABSTRACT

The invention relates to a navigation device (100) comprising: an inertial measurement unit (110) which is suitable for generating inertial measurement data; and a speed measuring system (120) which is suitable for emitting at least one spatially focussed, preferably electromagnetic, wave at a predefined frequency and for receiving a frequency spectrum of the wave reflected from a reference object (200), in particular the earth's surface, wherein a Doppler shift of the predefined frequency makes it possible to determine a speed of the navigation device in the direction of radiation relative to the reference object (200). The navigation device (100) also has an estimation filter (130), in particular a Kalman filter, which is suitable for using the inertial measurement data generated by the inertial measurement unit (110) and the frequency spectrum received from the speed measurement system (120) as input data in order to determine a navigation solution of the navigation device (100) therefrom.

The present invention relates to a navigation device and a method for determining a navigation solution.

Inertial measurement units have long been used to create navigation solutions. In such inertial measurement units, measurement data from various inertial sensors, such as acceleration sensors or rotation rate sensors, are used to determine the motion of the measurement unit in space, i.e., to find a navigation solution for the intrinsically unknown three-dimensional navigation of the measurement unit in space.

The measured acceleration or rotation rate values represent second derivatives of the location with respect to time. Due to the integration of the measured values with respect to time, which is necessary to determine the navigation solution, the navigation solution by a purely inertial measurement unit will become increasingly inaccurate and thus unreliable over time.

It is known to circumvent this problem by comparing the inertial navigation solution with alternative position data at certain times in order to reduce previously accumulated errors. The state of the art in this case is to refer to global navigation satellite systems, GNSS, such as GPS, Glonass, Galileo and the like. These theoretically provide an exact position of the measurement unit or the vehicle carrying the measurement unit, which can be used to compensate for cumulative errors of the inertial measurement unit.

It is also known to combine GNSS signals and the measurement data from the inertial measurement unit in an estimation filter, which calculates (estimates) the next measured values and/or satellite signals on the basis of previously available data and then compares them with the actually measured data. If there is a deviation between estimated and measured data, the assumed state, i.e., the navigation solution and the location resulting therefrom, is corrected.

The amount of measurement information that can be processed in the estimation filter can also be increased in this process. For example, an additional check of height errors in aircraft by comparison with the results of a barometric height measurement is known.

An attempt is also known to achieve the correction of the inertial navigation solution independently of the availability of GNSS. In addition to the combination of various sensors, such as barometers, magnetometers, odometers and/or cameras, the use of a Doppler radar system has been proposed in particular, which allows determining the speed of the system from the Doppler shift of radar waves reflected from the earth's surface. In so doing, the monitoring of speed, preferably in several independent viewing directions, allows a navigation solution independent of the inertial measurement, which, similarly to the solution based on GNSS data, can be used for checking and correcting the inertial navigation solution.

However, the use of Doppler radar systems described above typically ignores the fact that, due to the actually given physical framework conditions during radar measurement, the reflected signal not only exhibits a frequency shift, but also forms a frequency spectrum characteristic of the respective reflection situation. Rather, the focus up to now has only been on a Doppler shift, namely on the main component of maximum intensity visible in the frequency spectrum. As a result, the navigation solutions calculated by means of Doppler radar systems do not achieve the accuracy required in order to be able to compensate for the failure of a GNSS signal, for example.

The object of the invention is therefore to provide a navigation device with an inertial measurement unit which can calculate a navigation solution using data generated by means of a speed measurement system, such as a Doppler radar system, which is sufficiently accurate to compensate for the temporary failure of a GNSS correction by the inertial measurement unit or can make the GNSS correction unnecessary.

This object is achieved by the subject matter of the independent claims.

In particular, a navigation device includes an inertial measurement unit, which is suitable for generating inertial measurement data, and a speed measurement system, which is suitable for emitting at least one spatially focused, preferably electromagnetic wave at a predefined frequency and receiving a frequency spectrum of the wave reflected from a reference object, in particular the earth's surface, wherein a Doppler shift of the predefined frequency allows determining a speed of the navigation device in the direction of emission relative to the reference object. The navigation device further includes an estimation filter, in particular a Kalman filter, which is suitable for using the inertial measurement data generated by the inertial measurement unit and the frequency spectrum received from the speed measurement system as input data in order to determine therefrom a navigation solution by the navigation device.

In the navigation device, inertial measurement data, such as acceleration measurements and rotation rate measurements, are therefore entered into an estimation filter in a manner known per se in order to generate a navigation solution therefrom. In addition, the estimation filter not only receives a single Doppler shift, i.e., a single speed value per speed measurement, but the entire frequency spectrum of the reflected wave (or the equivalent intensity distribution in the time domain). This allows the estimation filter to utilize all the information contained in the reflected wave, whereby the accuracy of the achievable navigation solution is increased.

The estimation filter can be suitable for calculating an estimated frequency spectrum received for a next point in time on the basis of the navigation solution determined based on the input data previously obtained, comparing the frequency spectrum actually received from the speed measurement system at this next point in time with the estimated frequency spectrum received, and correcting the navigation solution based on deviations between the estimated and the actually received frequency spectrums, preferably in such a way that the deviations are reduced.

The state of the navigation device in space can be determined from the previously determined navigation solution. This, in turn, makes it possible to calculate the speed and direction of the speed measurement device in relation to the reference object. This then results in an intensity distribution and a frequency spectrum of the reflected wave. If this estimated frequency spectrum is compared with the actually measured frequency spectrum, conclusions can be drawn about incorrect assumptions regarding the state variables and/or system equations used by the estimation filter.

In particular, differences between the position and speed values calculated by the estimation filter and the actual values will be reflected in differences between the estimated and the actually measured frequency spectrums. In so doing, differences between estimated and actually measured frequency spectrums can also occur in cases in which the main component of maximum intensity visible in the frequency spectrum is the same in both spectrums.

Thus, the use of the entire frequency spectrum is a better indication of a faulty navigation solution than the use of a single frequency component. The frequency spectrum thus provides a reliable indication of such differences and can be used for improved corrections of the state variables used by the estimation filter. In this way, the reliability and accuracy of the navigation device are increased.

The speed measurement system can be suitable for emitting three spatially focused waves at a predefined, possibly different frequency onto the reference object, wherein the main beam directions of the three spatially focused waves are linearly independent, and the estimation filter is suitable for using the frequency spectrums of the reflections of all three waves as input data. In this way, motion in space can be detected three-dimensionally by means of the speed measurement system. The frequency spectrums obtained in this way are therefore particularly suitable for improving the navigation solution in three-dimensional space.

The navigation device can further comprise an evaluation unit, which is suitable for deriving state parameters from the frequency spectrum received, which characterize the frequency spectrum received. In so doing, the state parameters, in addition to the Doppler shift and/or the speed derived therefrom relative to the reference object, comprise additional parameters characterizing the frequency spectrum received. In this case, the estimation filter is suitable for using the state parameters as input data for determining the navigation solution.

Instead of using the entire frequency spectrum, it can also be sufficient to characterize it through a set of parameters and enter these parameters into the estimation filter. For example, the Doppler shift of the emitted wave can be determined in a known manner from the main component of the frequency spectrum, i.e., the peak with the greatest intensity. In addition, further characteristic variables are established, such as the position of other peaks in the spectrum, the parameters of Gaussian fits at different peaks, the intensity distribution in the spectrum, the line width of various reflections and the like. By selecting meaningful parameters, it is easier and therefore faster to determine the navigation solution in the estimation filter. Since, however, further parameters of the spectrum are also taken into account in addition to the Doppler shift, the accuracy and reliability are increased compared to known systems.

Moreover, the navigation device can be suitable for receiving signals from a global navigation satellite system, GNSS, and the estimation filter can be suitable for using the GNSS signals as input data for determining the navigation solution. In this case, in addition to the inertial measurement data and the speed measurement data, GNSS position data is also available to support the navigation solution. This further increases the accuracy and reliability of the navigation solution.

In so doing, the estimation filter can be suitable for determining the navigation solution based on the inertial measurement data and the GNSS signals, when the GNSS signals are being received, and based on the inertial measurement data and the frequency spectrum received, when no GNSS signals can be received. The speed measurement data then serves to bridge a temporary failure of the GNSS signal. In this way, the inertial measurement data can also be used to calculate a reliable navigation solution, when no GNSS position data is available, as the error accumulation can be kept within a sufficiently small range by reverting to the frequency data.

The speed measurement system can, in this case, be a radar system that emits electromagnetic waves in the radio range, i.e., a Doppler radar system. However, the speed measurement system can also be a lidar system that emits laser light. The wavelength, in this case, can depend on the area of application and lie in the UV range, the visible range or the IR range, for example. In principle, however, speed measurement can be carried out with any device that emits waves the reflection of which can be measured. In addition to electromagnetic waves and especially radar waves, to which reference is mainly made in the present description, sound waves can also be used in particular.

An aircraft, in particular an autonomously flying aircraft, can be provided with a navigation device as described above, wherein the aircraft is suitable for being steered based on the navigation solution generated by the navigation device. The aircraft can be suitable for use in urban airspace. Due to its high reliability and accuracy, the navigation device enables safer steering of an aircraft, either through reliable information for a pilot in poor or limited visibility or through fully autonomous steering of the aircraft on the basis of the navigation solution.

A method for determining a navigation solution by means of a navigation device as described above comprises: generating inertial measurement data by the inertial measurement unit; emitting at least one spatially focused wave at a predefined frequency by the speed measurement system; receiving a frequency spectrum of the wave reflected from a reference object, in particular the earth's surface, by the speed measurement system, wherein a Doppler shift of the predefined frequency allows determining a speed of the navigation device in the direction of emission relative to the reference object; determining a navigation solution by the navigation device by the estimation filter by using the inertial measurement data generated by the inertial measurement unit and the frequency spectrum received from the speed measurement system as input data for the estimation filter.

The invention will be described in detail in the following text, with reference to the figures. The following description is purely exemplary and is not intended to be understood as being restrictive. The present invention is defined solely by the subject matter of the claims.

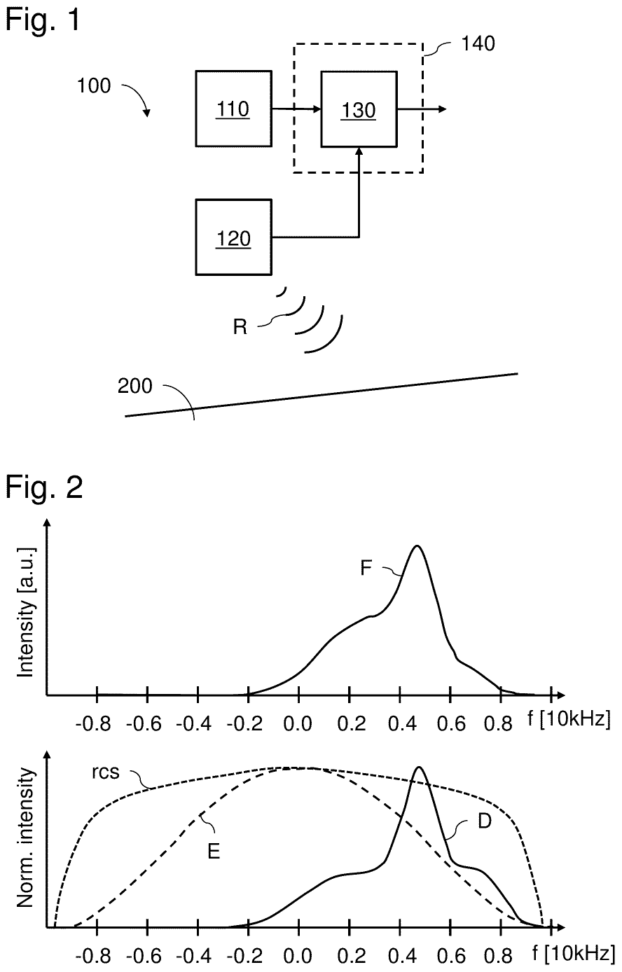

FIG. 1 shows a schematic representation of a navigation device;

FIG. 2 shows a schematic representation of frequency spectrums;

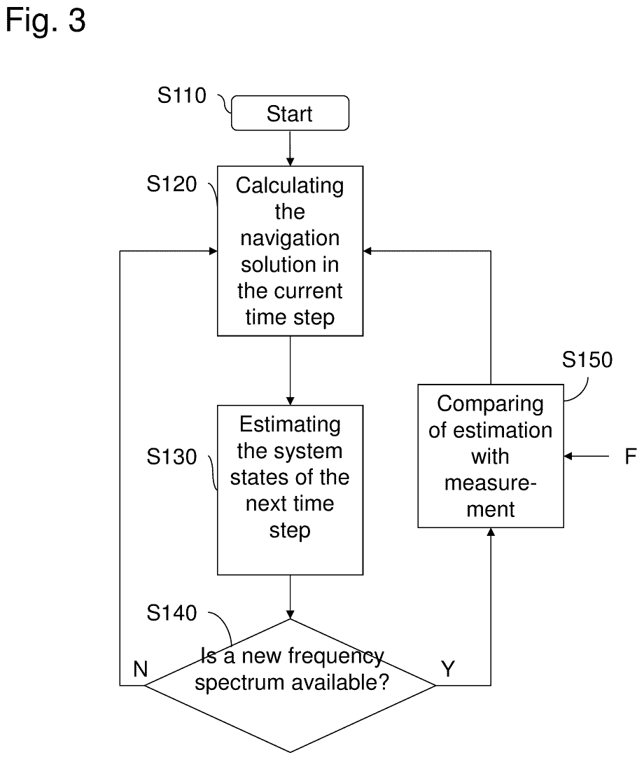

FIG. 3 shows a schematic flow chart of a calculation of navigation solutions;

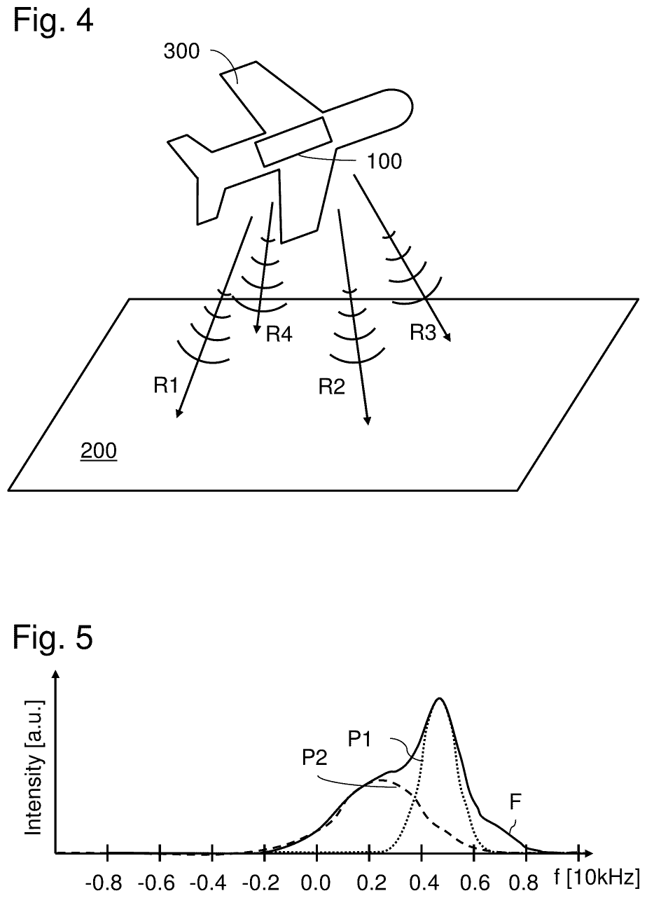

FIG. 4 shows a schematic representation of an aircraft with a navigation device;

FIG. 5 shows a schematic representation of a parameterization of a frequency spectrum;

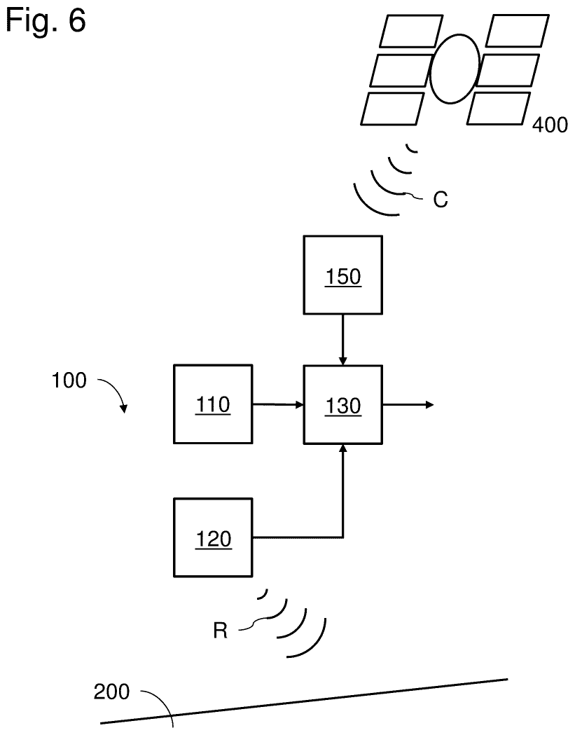

FIG. 6 shows another schematic representation of a navigation device; and

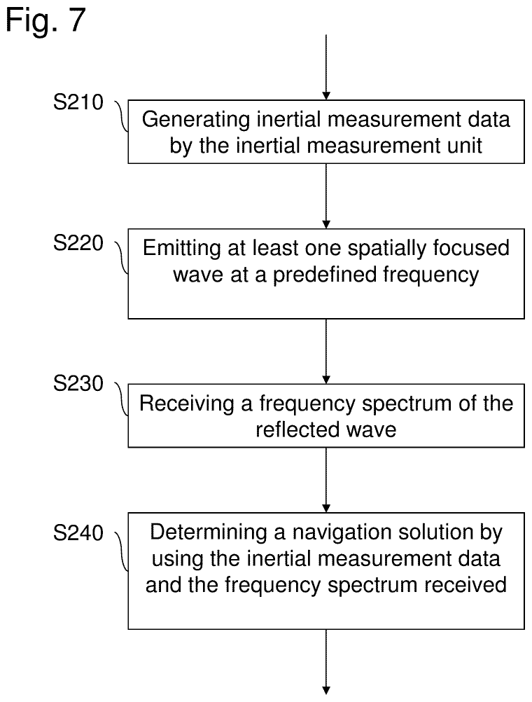

FIG. 7 shows a schematic flow chart of a method for determining a navigation solution.

FIG. 1 shows schematically a navigation device 100 that is in motion relative to a reference object 200. The navigation device 100 is, in this case, attached to a vehicle, for example, i.e., an aircraft, land vehicle or watercraft. The navigation device 100 is able to determine its previous movements through space from measurement data, i.e., the navigation device 100 determines a navigation solution from its previous movements or the movements of the vehicle to which it is attached.

For this purpose, the navigation device 100 includes an inertial measurement unit 110, a speed measurement system 120 and an estimation filter 130, which optionally is part of an evaluation unit 140 or is in data exchange with such an evaluation unit 140.

The inertial measurement unit 110 is suitable for generating inertial measurement data, i.e., measurement data caused by the inertia of the mass of the navigation device or its components relative to movements in space. In particular, the inertial measurement unit 110 is suitable for measuring acceleration along at least one of the three spatial directions and rotation rates of rotations about at least one of the three spatial axes. The inertial measurement unit 110 can, in this process, be configured in a known manner, e.g., as a micro-electro-mechanical acceleration/rotation rate sensor, as a fiber gyroscope or the like. The decisive factor in this case is that the inertial measurement unit 110 records measurement data which, in principle, allows the movements of the navigation device 100 in space to be calculated back, i.e., which allow a navigation solution to be determined, albeit a possibly inaccurate navigation solution.

The speed measurement system 120 is suitable for emitting at least one spatially focused, preferably electromagnetic wave R at a predefined frequency and receiving a frequency spectrum of the wave reflected from the reference object 200, preferably the earth's surface. A Doppler shift of the predefined frequency can then be used to determine a speed of the navigation device in the direction of emission relative to the reference object 200.

The speed measurement system 120 is thus suitable, in a manner known per se, for utilizing the Doppler effect in order to determine the relative movement between the navigation device 100 and the reference object 200 from the frequency of a reflected signal. The reference object 200 can, in this case, be regarded as stationary with regard to the speeds of the navigation device. For example, the reference object 200 can be the earth's surface or an elevation on the earth's surface, such as a mountain, a building or a tower, when the navigation device 100 is in motion outdoors. However, the reference object 200 can also be part of a building or a fitment, when the movement takes place inside a building or the like. In principle, the reference object 200 can also move itself. However, the navigation device 100 must then be provided with the navigation solution by the reference object 200 in order to determine its speed from the relative speed relative to the reference object.

The nature of the wave emitted by the speed measurement system 120 is, in principle, arbitrary and can be adapted to the intended purpose of the navigation device 100, as long as a transmitted signal of a predefined frequency makes it possible to establish a relative speed from the reflected signal relative to the reflection source via the Doppler effect. In the following text, it is assumed that the speed measurement system 120 is a Doppler radar system that emits radar waves of a specific frequency. Lidar systems that emit a laser beam and capture the reflection of this beam are also conceivable. Furthermore, sound waves can also be used.

However, the speed measurement system 120 does not measure a single reflection frequency corresponding to the emission frequency and shifted according to the Doppler effect. Rather, the emitted wave R is reflected at various angles from different objects. This results in different Doppler shifts for the various reflection angles, which are reflected as frequency components in the overall signal. The shape of the antenna pattern, the different distances to the reference object within the radar beam and additional effects can contribute to this. Frequency spectrum F of these different signals is generated from the time course of the reflection intensity in the usual way, e.g., through a Fourier transformation such as a discrete Fourier transformation or a fast Fourier transformation.

An example of such a frequency spectrum is depicted in FIG. 2. FIG. 2 shows frequency spectrum F in the upper figure, in which Doppler shift f is plotted against the intensity. Although the actual frequency shift can be clearly seen at approx. 5 kHz, frequency spectrum F also has other clearly visible components. The lower part of FIG. 2 shows various components of spectrum F that have been normalized to the same maximum value. In addition to actual Doppler identifier D, frequency spectrum F also contains a portion E that can be traced back to the distance, and a portion rcs that can be traced back to the radar cross section (rcs). Frequency spectrum F therefore contains a variety of other information in addition to the pure speed information.

For this reason, not only the frequency shift of the emission frequency or the corresponding speed information, but the entire frequency spectrum is made available to the estimation filter 130 in the navigation device 100. The inertial measurement data generated by the inertial measurement unit 110 and the frequency spectrum received from the speed measurement system 120 are used as input data by the estimation filter 130, which, in particular, can be a Kalman filter in order to determine therefrom a navigation solution by the navigation device 100.

The estimation filter 130 essentially works here in a manner known per se, i.e., based on known state values, states are estimated for the next time step, which can then be compared with actually measured values. From this comparison, changes are made to the state of the system that bring the estimate into better agreement with the measured values and the procedure is iterated.

This is exemplified in the flow chart in FIG. 3. After initialization of the system at S110, a navigation solution for the current time step is calculated at S120, which indicates the movement of the navigation device 100, preferably in three-dimensional space. Based on this, the states for the next time step are estimated at S130. Among other things, these allow an expected frequency spectrum to be calculated. At S140, a query is made as to whether a new frequency spectrum can be made available by the speed measurement system. If this is not the case (N), the procedure continues with step S120. If a new frequency spectrum is available (Y), the estimated spectrum is compared with the measured spectrum at S150, and the result of the comparison is used in the calculation of the navigation solution at S120.

The estimation filter 130 is thus suitable for calculating an estimated frequency spectrum received for a next point in time on the basis of the navigation solution determined based on the input data previously obtained, comparing frequency spectrum F actually received from the speed measurement system at this point in time with the estimated frequency spectrum received, and correcting the navigation solution based on deviations between the estimated and the actually received frequency spectrums, preferably in such a way that the deviations are reduced.

Processing entire frequency spectrum F instead of only the strongest frequency component entails a parameter gain that enables a more precise monitoring of the states propagated on the basis of the system equations. In this way, the accuracy and reliability of the calculated navigation solution is increased.

Preferably, the speed measurement system 120 is suitable for emitting three spatially focused waves at a predefined, possibly different frequency onto the reference object 200, wherein the main beam directions of the three spatially focused waves are linearly independent. Such an arrangement is exemplified in FIG. 4.

Here, an aircraft 300 carries the navigation device 100, which is equipped with a speed measurement system 120 constituted as a Doppler radar system. The aircraft 300 can, in this case, be a conventional aircraft such as an airplane or a helicopter. However, the aircraft 300 can also be an autonomously or semi-autonomously flying aircraft that navigates predominantly or exclusively by means of the navigation solution determined by the navigation device 100. In particular, the aircraft 300 can be suitable for use in urban space.

The Doppler radar, for example, emits four radar waves R1, R2, R3, R4 in the direction of the earth's surface, which are reflected from there. In so doing, the radar waves R1, R2, R3, R4 are preferably transmitted and received separately in time, are coded differently, modulated differently or have frequencies that differ from each other in such a way that the reflections received can be assigned to the respective waves. Alternatively or additionally, the overall spectrum of all reflections can also be further processed.

Three of the four radar waves R1, R2, R3, R4 are linearly independent. Ideally, each triple of radar waves is linearly independent. This means that movements in all three spatial directions can be read from the radar waves. It goes without saying that exactly three waves can also be used instead of four, and that the use of more than four waves is also possible.

The estimation filter 130 uses the frequency spectrums of the reflections of all electromagnetic waves as input data. This further expands the parameter space for the estimation filter 130, whereby reliability and accuracy can be further improved. In particular, by estimating and comparing a plurality of frequency spectrums or their superposition(s), the estimation filter 130 can more easily identify errors in the estimated states used and thus bring the navigation solution in line with the actual movement.

As shown in FIG. 1, the navigation device 100 can optionally include an evaluation unit 140, which is suitable for deriving state parameters from frequency spectrums received, which characterize the frequency spectrum received. The evaluation unit 140 can, in this case, be a hardware or software component. For example, the evaluation unit 140 can be a computer, a processor, a circuit or a program executed on any one of these components.

In addition to the Doppler shift and/or the speed derived therefrom relative to the reference object 200, the state parameters identified by the evaluation unit 140 have additional parameters characterizing the frequency spectrum received. The state parameters thus represent a characterization of frequency spectrum F that lies between the full spectrum, i.e., the full information, and the speed that can be derived therefrom, i.e., the minimum information. In this way, firmly predefined working parameters can be made available to the estimation filter 130. Compared to the full spectrum, this can reduce the computational effort for estimation and comparison. On the other hand, the estimation filter 130 receives more information compared to the pure speed information, whereby the accuracy and reliability of the navigation solution can be improved.

An example of such a parameterization is shown in FIG. 2, where the overall spectrum has been broken down into individual components that parameterize the spectrum. Another example is shown in FIG. 5, in which two Gaussian curves have been fitted to spectrum F. Curve P1, with its mean value and standard deviation, represents a parameterization of the Doppler shift. Curve P2, with its mean value and standard deviation, forms a parameterization of the overwhelming majority of the remaining causes for the shape of the spectrum. In this way, an attempt can be made to essentially describe the complete spectrum with a set of state parameters.

The estimation filter 130 is suitable for using these state parameters as input data for determining the navigation solution. This means that the complete spectrums are no longer estimated and compared, but only the state parameters of the spectrums. This reduces the computational effort and, due to the fact that a majority of parameters have been derived from the frequency spectrum, nevertheless leads to a reliable and accurate solution.

As shown in FIG. 6, the navigation device 100 can also be suitable for receiving signals from a global navigation satellite system, GNSS, 400, e.g., via a communication unit 150. These GNSS signals can also be supplied to the estimation filter 130 in a manner known per se, which then uses them to determine the navigation solution. This makes the navigation solution more accurate and reliable, since, in addition to acceleration data (inertial measurement unit 110) and speed data (speed measurement system 120), position data (GNSS 400) is also available. This position data can be estimated in a manner known per se and compared with the actually measured position in order to correct the system equation or the navigation solution and bring it in line with the actual movement.

The estimation filter 130 can, in this case, be suitable for determining the navigation solution based on the inertial measurement data and the GNSS signals, when the GNSS signals are being received. A reliable and accurate navigation solution is thereby generated in accordance with the typical requirements. If no GNSS signals can be received during a certain period, the estimation filter 130, on the contrary, determines the navigation solution based on the inertial measurement data and the frequency spectrum received.

This means that the frequency data is used to bridge a period in which GNSS reception is not possible. In this way, the navigation solution can be supported by measurement data that differs from the inertial measurement data and can therefore be kept within an accuracy range that is in line with the typical requirements. In normal operation, i.e., when all measurement data (inertial measurement, speed determination, position determination) is available, a highly accurate and reliable navigation solution can be determined thereby. If certain measurement data, such as the GNSS signal, fails, the time period until the quality of the navigation solution is no longer acceptable is extended thereby in contrast to conventional operation. This time period is further increased by the use of information from the frequency spectrum received. This increases the reliability of the overall system, as failures of the GNSS can be compensated for.

A method corresponding to the above description for determining a navigation solution by means of a navigation device 100 is shown schematically in FIG. 7. Here, inertial measurement data is generated by the inertial measurement unit 110 at S210.

At S220, at least one spatially focused, preferably electromagnetic wave at a predefined frequency is emitted by the speed measurement system 120.

At S230, a frequency spectrum of the wave reflected from a reference object 200, in particular the earth's surface, is received from the speed measurement system 120, wherein a Doppler shift of the predefined frequency allows determining a speed of the navigation device 100 in the direction of emission relative to the reference object 200.

At S240, a navigation solution by the navigation device 100 is determined by the estimation filter 130 by using the inertial measurement data generated by the inertial measurement unit 110 and the frequency spectrum received from the speed measurement system 120 as input data for the estimation filter 130.

In this way, a navigation solution can be generated in an accurate and reliable manner.

1.-9. (canceled)

10. A navigation device, including:
an inertial measurement unit which generates inertial measurement data;
a speed measurement system, which emits at least one spatially focused, preferably electromagnetic wave at a predefined frequency and determines a frequency spectrum from a reflection intensity of the wave reflected from a reference object, in particular the earth's surface, wherein a Doppler shift of the predefined frequency allows determining a speed of the navigation device in the direction of emission relative to the reference object; and
an estimation filter, in particular a Kalman filter, which uses the inertial measurement data generated by the inertial measurement unit and the frequency spectrum determined by the speed measurement system as input data in order to determine therefrom a navigation solution by the navigation device, which indicates a previous movement of the navigation device in space, wherein
the estimation filter calculates an estimated frequency spectrum for a next point in time on the basis of the navigation solution determined based on the input data previously obtained, compares the frequency spectrum actually determined by the speed measurement system at this next point in time with the estimated frequency spectrum, and corrects the navigation solution based on deviations between the estimated and the actually determined frequency spectrums, preferably in such a way that the deviations are reduced.

11. The navigation device according to claim 10, wherein
the speed measurement system emits three spatially focused waves at a predefined, possibly different frequency onto the reference object;
the main beam directions of the three spatially focused waves are linearly independent; and
the estimation filter uses the frequency spectrums of the reflections of all three waves as input data.

12. The navigation device according to claim 10, further comprising:
an evaluation unit which derives state parameters from the frequency spectrum determined, which characterize the frequency spectrum determined; wherein
the state parameters, in addition to the Doppler shift and/or the speed derived therefrom relative to the reference object, comprise additional parameters characterizing the frequency spectrum determined; and
the estimation filter does not use the full frequency spectrum, but rather the state parameters as input data for determining the navigation solution.

13. The navigation device according to claim 10, wherein
the navigation device receives signals from a global navigation satellite system, GNSS; and
the estimation filter uses the GNSS signals as input data for determining the navigation solution.

14. The navigation device according to claim 13, wherein
the estimation filter determines the navigation solution based on the inertial measurement data and the GNSS signals, when the GNSS signals are being received; and
the estimation filter determines the navigation solution based on the inertial measurement data and the frequency spectrum determined, when no GNSS signals can be received.

15. The navigation device according to claim 10, wherein
the speed measurement system is a radar system that emits electromagnetic waves in the radio range or a lidar system that emits laser light.

16. An aircraft, in particular an autonomously flying aircraft, with a navigation device according to claim 10, wherein
the aircraft is being steered based on the navigation solution.

17. A method for determining a navigation solution by means of a navigation device according to claim 10, comprising:
generating inertial measurement data by the inertial measurement unit;
emitting at least one spatially focused, preferably electromagnetic, wave at a predefined frequency by the speed measurement system;
determining a frequency spectrum from a reflection intensity of the wave reflected from a reference object, in particular the earth's surface, by the speed measurement system, wherein a Doppler shift of the predefined frequency allows determining a speed of the navigation device in the direction of emission relative to the reference object;
determining a navigation solution by the navigation device by the estimation filter by using the inertial measurement data generated by the inertial measurement unit and the frequency spectrum received from the speed measurement system as input data for the estimation filter, wherein
the estimation filter calculates an estimated frequency spectrum for a next point in time on the basis of the navigation solution determined based on the input data previously obtained, compares the frequency spectrum actually determined by the speed measurement system at this next point in time with the estimated frequency spectrum, and corrects the navigation solution based on deviations between the estimated and the actually determined frequency spectrums, preferably in such a way that the deviations are reduced.
